(19) United States
(12) Patent Application Publication
(10) Pub. No.: US 2018/0056321 A1
(43) Pub. Date: Mar. 1, 2018

(54) Device for Applying a Hot-Melt to a Web of Material

(71) Applicant: Maan Research & Development B.V., Raalte (NL)

(72) Inventors: Andreas Willibrordus Maria Jansen, Wijhe (NL); Sjoerd Maria Jansen, Raalte (NL)

(21) Appl. No.: 15/558,320

(22) PCT Filed: Mar. 16, 2016
(86) PCT No.: PCT/EP2016/055658

§ 371 Date: Sep. 14, 2017

(30) Foreign Application Priority Data
Mar. 17, 2015 (EP) 15159322.5

(51) Int. Cl. B05C 1/08; B05C 1/16; B05D 1/28

(52) U.S. Cl. CPC B05C 1/0813; B05D 1/28; B05C 1/165; B05C 1/0826

(57) ABSTRACT

The invention relates to a device for applying a hot-melt to a web of material. The device includes a driven roller and a nozzle with a nozzle channel arranged adjacent the driven roller for supplying a hot melt through the nozzle channel to the surface of the roller. The invention also relates to a combination of a device according to the invention and a web of material, which web of material is guided along the driven roller and wherein the nozzle channel exits in front of the nip of the web of material and the driven roller.

The invention relates to a device for applying a hot-melt to a web of material, which device comprises:
a driven roller;
a nozzle with a nozzle channel arranged adjacent the driven roller for supplying a hot melt through the nozzle channel to the surface of the roller.

Such a device is for example known from GB 1266745 or U.S. Pat. No. 3,818,860.

GB 1266745 discloses a driven roller along which a web of material is guided. An extrusion nozzle is furthermore provided and positioned close to the web, such that the web of material is arranged between the roller and the extrusion nozzle.

In order to achieve a thin and even film of extruded material, the space between the exit opening of the extrusion nozzle and the surface of the web of material needs to be small. This has the disadvantage that dirt particles and the like could get stuck between the nozzle and the web of material, such that tracks are caused in the resulting film of extruded material.

U.S. Pat. No. 3,818,860 discloses a driven roller along which a conveyor belt is arranged. Through a nozzle a fluid is deposited onto the conveyor belt and a blade smooths the fluid out to a preset thickness. The conveyor belt with the layer of fluid is transported further to a contact area, where a sheet of material is inserted into the nip of the roller and a counter object. At said nip, the fluid on the conveyor belt is transferred to the sheet of material.

However, due to the nip between the roller and the counter object, not all of the fluid will be transported with the same speed as the rotating speed of the roller through the nip. This will cause an accumulation of fluid, which adversely influences the resulting thickness and evenness of the film on the sheet of material.

Especially when long webs of material are provided with a layer of fluid, such as for example tapes with an adhesive layer, any small unevenness in the thickness will result in a substantial unevenness when the long web is rolled up. This is the result of the multiplication by each winding on the roll of the small unevenness.

It is an object of the invention to reduce or even remove the above mentioned disadvantages.

This object is achieved with a device according to the preamble, which device is characterized in that the nozzle channel is in flow direction, at least over a part of the circumference of the roller, parallel to the surface of the roller.

Because the nozzle channel is parallel to the surface of the roller, in flow direction, the direction of movement of the roller and the direction of the flow hot melt exiting the nozzle will be the same, contributing to a more even layer of hot melt on the roller.

Preferably the flow direction is tangential to the circumference of the roller.

In a preferred embodiment of the device according to the invention the nozzle channel is at least partially bounded by a part of the surface of the roller.

In this embodiment, the nozzle channel is partly formed by the surface of the roller. This has the advantage that the hot melt is already in contact with the surface of the roller, while it is still flowing within the nozzle channel. When the hot melt exits the nozzle it will be fully at the same speed as the roller and the flow direction will be the same as the direction of movement of the roller, which will result in a very smooth and even layer of hot-melt on the roller.

Another advantage of the feature that the nozzle channel is at least partially bounded by the surface of the roller, is that the thickness of the resulting layer of hot-melt can easily be controlled by controlling the rotation speed of the roller.

In a further preferred embodiment of the device according to the invention the nozzle channel is provided in transverse direction, perpendicular to the flow direction, at least one partition wall to apply the hot-melt in tracks to the web of material.

With the device according to the invention, the hot melt is applied in the desired thickness. There is no need to have an accumulation of hot melt at the nip. Now, by providing at least one partition wall, the hot melt can be applied in tracks, which are accurately defined and will not be disturbed by any accumulation, as would be with the devices according to the prior art.

Preferably, the at least one partition wall is provided by an elevation arranged in a nozzle channel wall. Typically, the nozzle channel will be formed by a metal body which is milled into the required shape. The elevations can easily be provided in the metal body.

In a still further preferred embodiment of the device according to the invention the elevation is virtually in contact with the opposite wall of the nozzle channel.

Preferably, the nozzle channel is bounded by a part of the surface of the roller, in flow direction, over at least a twentieth of the circumference of the roller. This provides for a sufficient long contact time between the hot-melt flowing through the channel and the roller.

Furthermore, it is preferred that the nozzle channel is in flow direction, over at least a tenth of the circumference of the roller, parallel to the roller.

The invention also relates to a combination of a device according to the invention and a web of material, which web of material is guided along the driven roller and wherein the nozzle channel exits in front of the nip of the web of material and the driven roller.

By having the hot-melt exiting the nozzle in front of the nip, the layer of hot-melt on the roller can directly be transferred onto the web of material. Because it is not further necessary to control the thickness of the layer of hot-melt, any dirt particles trapped in the hot melt, will easily be transported along on the web of material, without causing any tracks or major disturbances.

Preferably, the distance between the exit of the nozzle and the nip of the web of material and the driven roller is less than 10 mm.

These and other features of the invention will be elucidated in conjunction with the accompanying drawings.

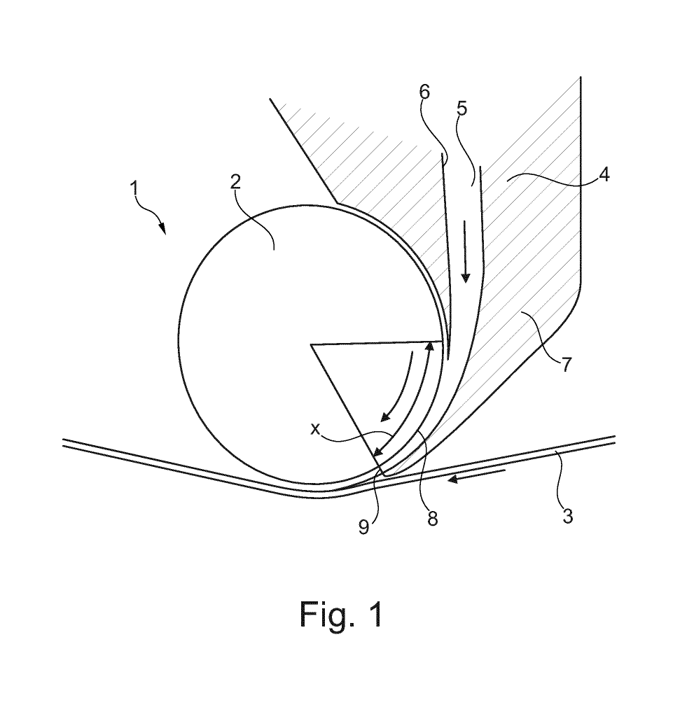

FIG. 1 shows a side view of an embodiment of the device according to the invention.

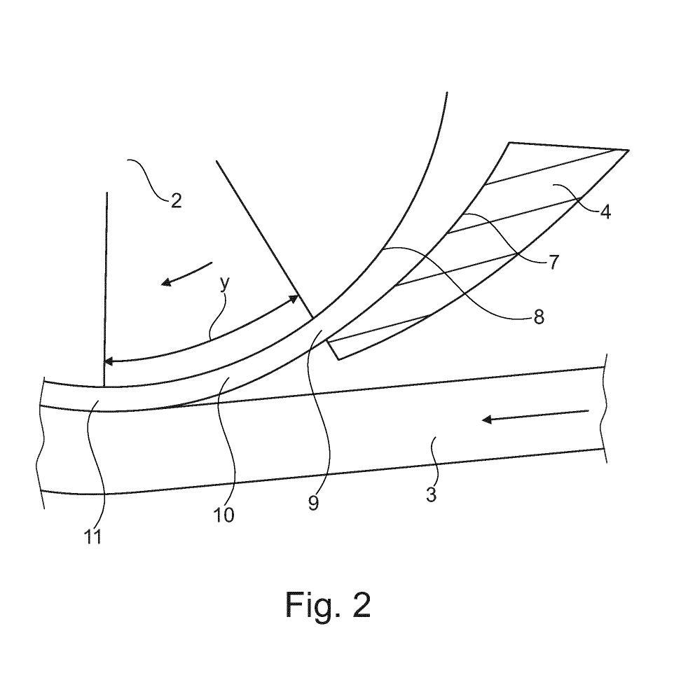

FIG. 2 shows an enlarged view of part of FIG. 1.

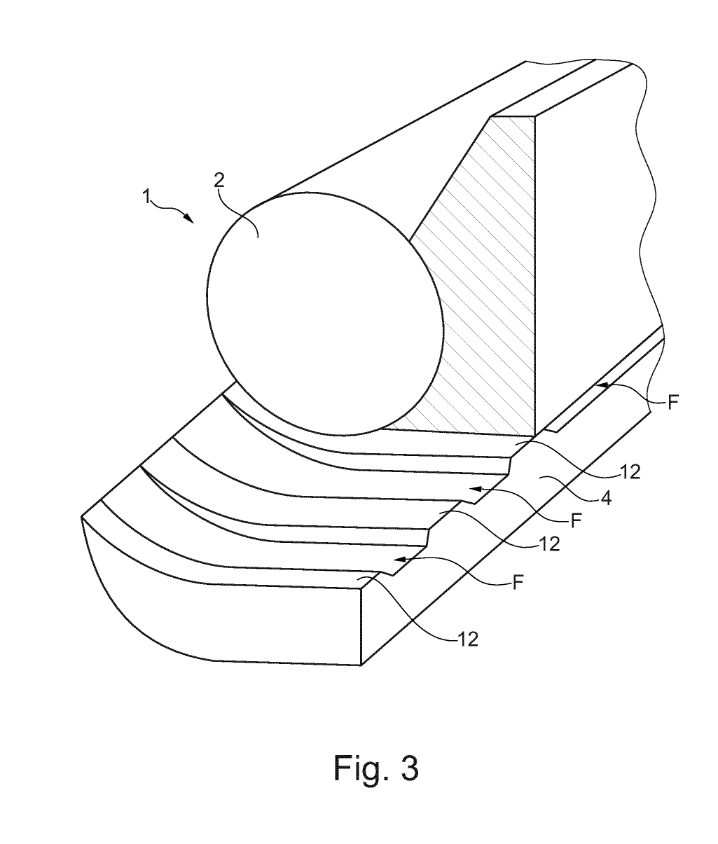

FIG. 3 shows a perspective view of the embodiment of FIG. 1.

FIG. 1 shows a side view of an embodiment of the device 1 according to the invention. The device 1 has a driven roller 2 along which a web of material 3, such as a paper web, is guided.

Furthermore, a nozzle 4 is provided adjacent to the roller 2. The nozzle 4 has a nozzle channel 5 through which a fluid, such as a hot-melt, is supplied. The nozzle channel 5 has channel walls 6, 7. As the channel wall 6 is shorter than the channel wall 7, the nozzle channel 5 is also bounded by a part of the surface 8 of the roller 2 over a distance x of the circumference of the roller 2.

As can be seen in more detail in FIG. 2, the fluid exits at the tip 9 of the nozzle 4 and provides a layer 10 of fluid on the roller 2. As the fluid was already in contact with the roller 2 over the distance x and because the channel 5 has been parallel to the surface of the roller, a very even and thin layer 10 of fluid can be provided.

When the fluid layer 10 arrives at the nip 11 between the roller 2 and the web of material 3, the fluid layer 10 is transferred onto the web of material 3.

Preferably, the distance y between the tip 9 of the nozzle 4, where the fluid exits the nozzle 4, and the nip 11 is less than 10 mm. This ensures that the layer of fluid 10 is not disturbed between exiting the nozzle 4 and the nip 11, where the layer 10 is transferred onto the web of material 3.

FIG. 3 shows a perspective view of the embodiment 1 of FIG. 1. The nozzle channel 5 is provided in transverse direction, perpendicular to the flow direction F, with a number of elevations 12, which provide partition walls, such that tracks of hot-melt can be applied to the web of material 3.

1. A device for applying a hot-melt to a web of material, which device comprises:
a driven roller; and
a nozzle with a nozzle channel arranged adjacent the driven roller for supplying a hot-melt through the nozzle channel to the surface of the roller;
wherein
the nozzle channel is in flow direction, at least over a part of the circumference of the roller, parallel to the surface of the roller.

2. The device according to claim 1, wherein the flow direction is tangential to the circumference of the roller.

3. The device according to claim 1, wherein the nozzle channel is at least partially bounded by a part of the surface of the roller.

4. The device according to claim 3, wherein the nozzle channel is bounded by a part of the surface of the roller, in flow direction, over at least a twentieth of the circumference of the roller.

5. The device according to claim 1, wherein the nozzle channel is provided in transverse direction, perpendicular to the flow direction, at least one partition wall to apply the hot-melt in tracks to the web of material.

6. The device according to claim 5, wherein the at least one partition wall is provided by an elevation arranged in a nozzle channel wall.

7. The device according to claim 6, wherein the elevation is virtually in contact with the opposite wall of the nozzle channel.

8. The device according to claim 1, wherein the nozzle channel is in flow direction, over at least a tenth of the circumference of the roller, parallel to the roller.

9. A combination of a device according to claim 1 and a web of material, which web of material is guided along the driven roller and wherein the nozzle channel exits in front of the nip of the web of material and the driven roller.

10. The combination according to claim 9, wherein the distance between the exit of the nozzle and the nip of the web of material and the driven roller is less than 10 mm.

11. The device according to claim 2, wherein the nozzle channel is at least partially bounded by a part of the surface of the roller.

12. The device according to claim 11, wherein the nozzle channel is bounded by a part of the surface of the roller, in flow direction, over at least a twentieth of the circumference of the roller.

13. The device according to claim 2, wherein the nozzle channel is provided in transverse direction, perpendicular to the flow direction, at least one partition wall to apply the hot-melt in tracks to the web of material.

14. The device according to claim 3, wherein the nozzle channel is provided in transverse direction, perpendicular to the flow direction, at least one partition wall to apply the hot-melt in tracks to the web of material.

15. The device according to claim 4, wherein the nozzle channel is provided in transverse direction, perpendicular to the flow direction, at least one partition wall to apply the hot-melt in tracks to the web of material.

16. The device according to claim 11, wherein the nozzle channel is provided in transverse direction, perpendicular to the flow direction, at least one partition wall to apply the hot-melt in tracks to the web of material.

17. The device according to claim 12, wherein the nozzle channel is provided in transverse direction, perpendicular to the flow direction, at least one partition wall to apply the hot-melt in tracks to the web of material.
